(19) United States
(12) Patent Application Publication
(10) Pub. No.: US 2023/0350402 A1
(43) Pub. Date: Nov. 2, 2023

(54) MULTI-TASK LEARNING BASED RUL PREDICATION METHOD UNDER SENSOR FAULT CONDITION

(71) Applicant: TIANJIN UNIVERSITY, Tianjin (CN)

(72) Inventors: Ruonan LIU, Tianjin (CN); Kai ZHANG, Tianjin (CN)

(21) Appl. No.: 18/137,832

(22) Filed: Apr. 21, 2023

(30) Foreign Application Priority Data
Apr. 28, 2022 (CN) 202210460296.X

(51) Int. Cl. G05B 23/02

(52) U.S. Cl. CPC G05B 23/0283; G05B 23/024

(57) ABSTRACT

A multi-task learning-based remaining useful life prediction method under a sensor fault condition, including the following steps: firstly, preprocessing data with missing values by a sliding window to construct the data into data samples in a sequential pattern; then, fully fusing spatio-temporal information in the data by a deep long short-term memory (LSTM) module to extract implicit representations containing complete degradation information; next, inputting the implicit representations extracted from the deep LSTM module into a missing value imputation module and an RUL prediction task module by a multi-task learning method in parallel, thereby ensuring that the implicit representations contain as complete degradation information as possible with the aid of a missing value imputation task to obtain accurate RUL prediction results.

### CROSS-REFERENCE TO RELATED APPLICATIONS

This application claims priority from Chinese patent application CN202210460296.X filed 2022 Apr. 28, the content of which are incorporated herein in the entirety by reference.

### TECHNICAL FIELD

The present disclosure belongs to the fields of industrial big data, PHM and machine learning, and is applied to RUL prediction tasks of industrial systems under the condition of missing monitoring data due to sensor faults. The present disclosure particularly relates to a multi-task learning-based RUL prediction method in a sensor fault.

### BACKGROUND

Remaining Useful Life (RUL) prediction is an important part in the field of Prognostics and Health Management (PHM). The RUL prediction technology aims to accurately predicate the service life of mechanical equipment, so as to carry out rational maintenance and management accordingly and guarantee safety, reliability and economy of equipment operation. The results of RUL prediction provide scientific basis for maintenance, replacement, spare parts ordering and other health management activities of the equipment. The RUL prediction technology provides available information based on real-time and historical status monitoring data generated by sensor networks installed on the equipment, and reduces the time and costs for products or process maintenance by efficient and cost-effective prediction activities, and therefore the intelligent decision is achieved to improve performance, security, reliability and maintainability. The analysis of an engineering application technology shows that the RUL prediction technology can predict and manage potential future risks resulting from systems, to ensure that machines and equipment can run more securely and reliably.

The RUL prediction technology generally includes a model-based method and a data-driven method. The RUL prediction method stated in this patent is a typical data-driven RUL prediction method. The data-driven method is to obtain potential rules from collected historical operation data of the equipment to speculate operational health status of new equipment and predict RUL thereof. A general process of RUL prediction in the data-driven method includes: data acquisition→data preprocessing→model design→model training →RUL prediction→>decision maintenance. The data-driven method may be further divided into a supervised method and an unsupervised method, which depends on whether raw data used for constructing a prediction model has tag information, namely, life information or fault information. With the wide application of a sensor technology and continuous improvement of computing power, the data-driven method represented by a deep learning technology is widely applied in the RUL prediction.

In this patent, a time series neural network model (called a Long Short-Term Memory (LSTM) network) commonly used in the field of machine learning is used in the provided method. The LSTM is widely applied in natural language processing and speech signal processing, and achieves good effects. The LSTM may process time series data, and model a time series correlation in the time series data, while data most commonly used in the RUL prediction is time series vibration signals collected from the equipment, and therefore the LSTM is also widely applied in the RUL prediction field. The LSTM consists of a plurality of basic cells, and the LSTM structure expanded in time series is shown in FIG. 1:

Each LSTM cell internally includes three control gates which are an input gate, a forget gate and an output gate respectively, three of which are implemented by controlling the transmission of data flow by gate signals generated by using input data. The function of the input gate is to selectively determine which information in the input data will be entered, the forget gate is to selectively forget data entered in a previous iteration, and the output gate is to determine which information will be output from the current iteration. The data flow in the LSTM cells may be described by the following formula:

iₜ=σ(wᵢ[xₜ,hₜ₋₁]+bᵢ),

fₜ=σ(w_{f}[xₜ,hₜ₋₁]+b_{f}),

oₜ=σ(wₒ[xₜ,hₜ₋₁]+b_{g}),

gₜ=tanh(w_{g}[xₜ,hₜ₋₁]+b_{g}),

cₜgₜ*iₜ+cₜ₋₁*fₜ,

hₜ=tanh(cₜ)*oₜ

Technical Problem as yet Unsettled

In actual RUL prediction application scenarios, a multi-sensor network needs to be disposed on monitored equipment to collect monitoring data, and therefore the RUL prediction is performed by using information in the monitoring data. However, a large number of uncontrollable interference factors, such as vibration, dust, chemical corrosion and electromagnetic interference, exist in industrial fields, which has adverse effects on the sensors installed on the industrial equipment, and processes such as data transmission and read-write, and consequently the collected multi-sensor monitoring data has random missing values. Such data missing problem is quite common in practical data-driven RUL prediction applications. Therefore, a technical problem to be solved is how to perform more accurate RUL prediction under the condition that the collected monitoring data has random missing values.

### SUMMARY

In order to overcome the shortcomings in the prior art, the present disclosure aims to fully utilize multi-sensor monitoring data with missing values to achieve more accurate RUL prediction under the condition that real-time monitoring data has such missing values. For this purpose, the present disclosure adopts the following technical solution: a multi-task learning-based RUL prediction method under a sensor fault condition includes the following steps: firstly, preprocessing data with missing values by a sliding window to construct the data into data samples in a sequential pattern; then, fully fusing spatio-temporal information in the data by a deep long short-term memory (LSTM) module to extract implicit representations containing complete degradation information; and next, inputting the implicit representations extracted from the deep LSTM module into a missing value imputation module and an RUL prediction task module in parallel by a multi-task learning method, thereby ensuring that the implicit representations contain as complete degradation information as possible with the aid of a missing value imputation task to obtain accurate RUL prediction results.

The detailed steps are as follows:

A. Data Preprocessing

Representing a set of collected monitoring data with a matrix X=[x₁, x₂, x₃, x₄, x₅, . . . , x_{T}], wherein T represents a length of collected signals, a vector therein xₜ=[xₜ¹, xₜ², . . . , xₜ^{S},]^{T}, representing a vector consisting of monitoring signals collected from S sensors at the moment of t, each element xₜ^{S} in the vector represents signals collected from the S sensors at the moment of t, different sensors represent different monitoring features, and 0 represents the missing value;

partitioning the monitoring data X by a sliding window with a length of w along a time dimension at a step length of 1 for sliding window processing to obtain a plurality of samples {Xₜ} _{W}^{T}, where Xₜ=[x_{t-w+1}, x_{t-w+2}, . . . , xₜ], expanding each sample Xₜ into the vector zₜ=[x_{t-w+1}¹, x_{t-w+2}¹, . . . , x_{t-w+1}², x_{t-w+2}², . . . , xₜ², . . . xₜ^{S}], of which the dimensions are WxS; and obtaining T-w+1 vectors for X containing monitoring data for T moments in an n^{th} group through sliding window processing, and arraying these vectors in a time sequence to form an nth sample sequence Sₙ={z_{w}, z_{w+1}, . . . , z_{T}}, a plurality of which form a data set used for training and testing models;

B. Spatio-temporal Information Fusion

Fully fusing the spatio-temporal information in the input data by the deep LSTM model: for an input data sequence Sₙ={z_{w}, z_{w+1}, . . . , z_{T}}, inputting elements therein into the deep LSTM module in a time sequence iteratively, thereby ensuring that, at the moment of t, an implicit representation vector hₜ output from a cell at the moment of t corresponding to the LSTM at the last layer fuses information in all input data (namely {z_{w}, z_{w+1}, . . . , zₜ}) at and before the moment of t;

C. Multi-task Learning

Performing a missing data imputation task and an RUL prediction task in parallel by the multi-task learning method, obtaining the implicit representation hₜ containing complete information with the aid of the missing value imputation task, to obtain a higher RUL prediction accuracy by using the complete information in the hₜ;

specifically, inputting the implicit representation hₜ output at the moment of tin step C into the modules (the missing value imputation module and the RUL prediction module) corresponding to the two tasks simultaneously in parallel, wherein the missing value imputation module consists of a multilayer fully connected neural network, of which an output dimension corresponds to a dimension of input data zₜ; supposing that an output value of the missing value imputation module is \hat{z}ₜ, and complete data corresponding to input data zₜ with missing values is \tilde{z}ₜ, the purpose of the missing value imputation module is to shorten the distance between \hat{z}ₜ and \tilde{z}ₜ as far as possible, that is, imputation missing data in the input value zₜ at the moment of t, and computing an error of the missing value imputation module by mean square error (MSE) loss:

$${L}_{imp} = \frac{1}{( T - w + 1 ) D} {\sum }_{t = w}^{T} {‖ {\hat{z}}_{t} - {\tilde{z}}_{t} ‖}^{2}$$

where, D=wxS, which is the dimension of an output vector of the missing value imputation module, the recovery of the missing data from zₜ by the missing value imputation module is achieved by optimizing the above loss function, to ensure that the input implicit representation vector hₜ contains complete information in the complete data \tilde{z}ₜ at the moment of t;

meanwhile, inputting the implicit representation hₜ containing the complete information in the complete data \tilde{z}ₜ at the moment of t into the RUL prediction module in parallel, to achieve the RUL prediction task, wherein the RUL prediction module consists of a one-dimensional convolutional neural network (1d-CNN) and a fully-connected layer, the purpose of the (1d-CNN) is to further fully extract degradation features from the implicit representation hₜ, and then send the extracted degradation features into the fully-connected layer to obtain accurate RUL prediction results; as the input hₜ of the RUL prediction module is obtained with the aid of the missing value imputation module in parallel therewith, it contains the complete information at the moment of t; therefore, the hₜ is used for RUL prediction to obtain a high prediction accuracy, and supposing that a predicted value output from the RUL prediction module at the moment of t is ŷₜ, a real RUL value at the moment of t is yₜ, as the RUL prediction task is a regression problem, RUL prediction errors are computed by MSE loss frequently used in the regression problem:

$${L}_{pred} = \frac{1}{T - w + 1} {\sum }_{t = w}^{T} {( {\hat{y}}_{t} - {y}_{t} )}^{2}$$

A final loss function of the provided method is as follows:

L=L_{pred}+α·Lᵢₘₚ

Where, α is a hyper-parameter, which is used for balancing L_{pred} and Lᵢₘₚ, and needs to be determined by experiments.

The present disclosure has following characteristics and beneficial effects:

The multi-task learning-based RUL prediction method provided by the present disclosure can obtain good RUL prediction results under the condition that input data has random missing values, which is greatly improved compared with the RUL prediction method in which data with the missing values is used directly. Therefore, in practical RUL prediction applications, a higher RUL prediction accuracy can be effectively obtained under the condition of monitoring data missing due to widespread interference factors such as vibration and electromagnetic interference in industrial fields, and the influence of the interference factors on the RUL prediction is reduced as far as possible; the accuracy and reliability of monitoring of equipment are improved, and therefore equipment maintenance and management decisions are made properly to achieve robust and intelligent monitoring, maintenance and management of the industrial equipment.

### BRIEF DESCRIPTION OF THE DRAWINGS

FIG. 1 shows a structure of LSTM.

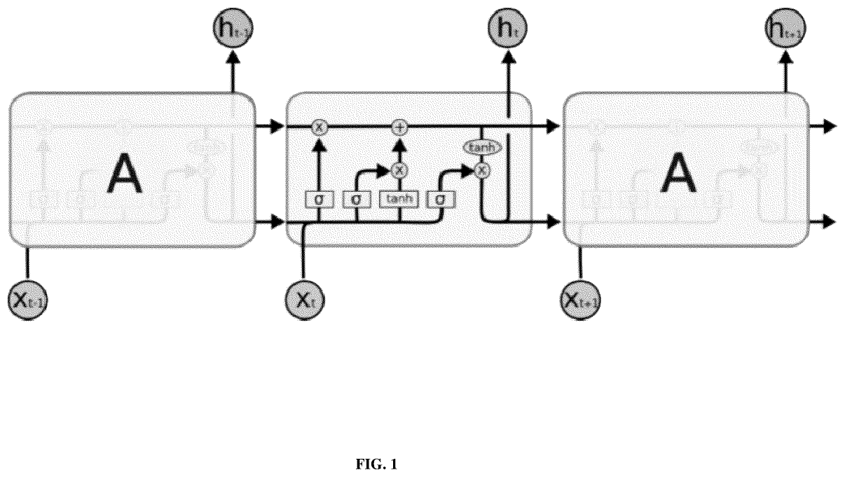

FIG. 2 shows sliding window processing (taking w=2 as an example).

FIG. 3 shows extraction of spatio-temporal features.

FIG. 4 shows multi-task learning.

FIG. 5 shows an application flow chart of a provided method.

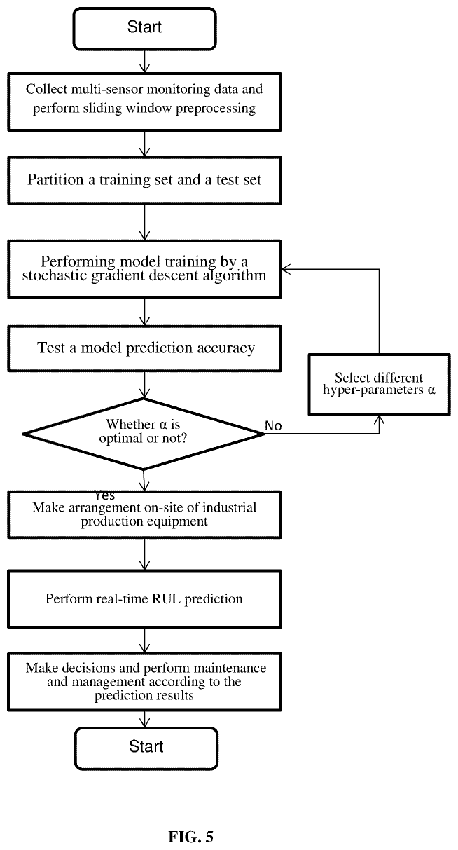

FIG. 6 shows RMSE results of different methods at different missing rates of a C-MAPSS(FD001) data set.

FIG. 7 shows a block diagram illustrating an exemplary computing system in which the present system and method can operate provided by an embodiment of the present disclosure.

### DETAILED DESCRIPTION

In practical RUL prediction applications, collected monitoring data frequently has random missing values due to interference from various factors. The present disclosure provides a multi-task learning-based RUL prediction method in order to fully utilize these multi-sensor monitoring data with missing values and perform more accurate RUL prediction under the condition that the real-time monitoring data has such missing values. Firstly, data with missing values is preprocessed by a sliding window to construct the data into data samples in a sequential pattern; then, spatio-temporal information is fully fused in the data by a deep long short-term memory (LSTM) module to extract implicit representations containing complete degradation information; next, the implicit representations extracted from the deep LSTM module are input into a missing value imputation module and an RUL prediction task module in parallel by a multi-task learning method, thereby ensuring that the implicit representations contain as complete degradation information as possible with the aid of a missing value imputation task to obtain more accurate RUL prediction results.

The specific solution in the present disclosure is as follows:

A. Data Preprocessing

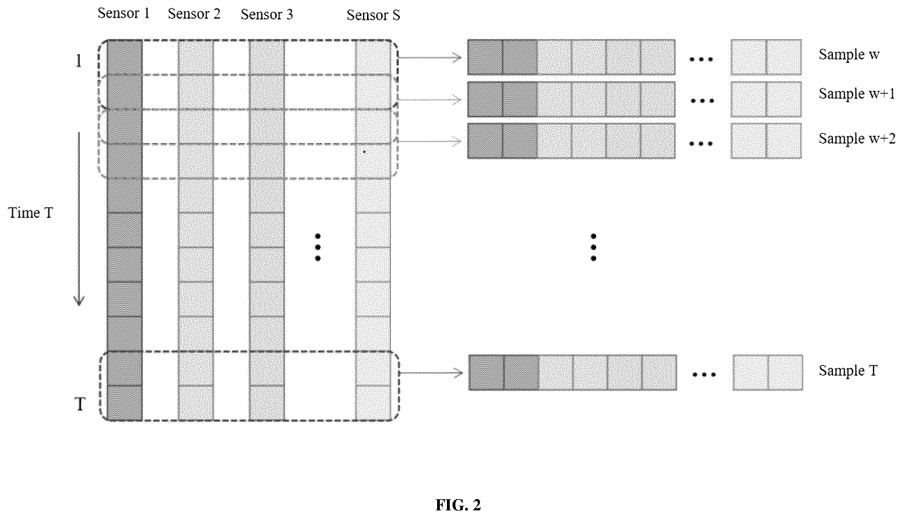

In RUL prediction applications, the structure of the collected multi-sensor monitoring data is a two-dimensional matrix, two dimensions are a time dimension and a sensor dimension respectively, and in the time dimension, data collection starts when the equipment is intact, till the end of the equipment life. In the sensor dimension, each dimension represents signals collected from sensors corresponding to this dimension. In order to construct the data into the form required by the method invented by this patent, the data is preprocessed by the sliding window, and the process thereof is shown in FIG. 2.

Specifically, a set of collected monitoring data is represented with a matrix X=[x₁, x₂, x₃, . . . , xₜ, . . . , x_{T}], wherein T represents a length of collected signals, a vector therein xₜ=[xₜ¹, xₜ², . . . , xₜ^{S},]^{T}, representing a vector consisting of monitoring signals collected from S sensors at the moment of t, each element xₜ^{s} in the vector represents signals collected from the S sensors at the moment of t, different sensors represent different monitoring features, and 0 represents missing values.

The monitoring data X is partitioned by a sliding window with a length of w along a time dimension at a step length of 1 for sliding window processing to obtain a plurality of samples{Xₜ}_{w}^{T}, where Xₜ=[x_{t-w+1}, x_{t-w+2}, . . . , xₜ], each of which is expanded into the vector zₜ=[x_{t-w+2}¹, x_{t-w+2}², . . . , xₜ¹, x_{t-w+2}², x_{t-w+2}², . . . , xₜ², . . . xₜ^{S}], having the dimensions of WxS; T-w+1 vectors may be obtained for X containing monitoring data for T moments in an nth set through sliding window processing, these vectors are arrayed in a time sequence to form an nth sample sequence Sₙ={z_{w}, z_{w+1}, . . . , z_{T}}, a plurality of which form a data set used for training and testing models.

B. Spatio-temporal Information Fusion

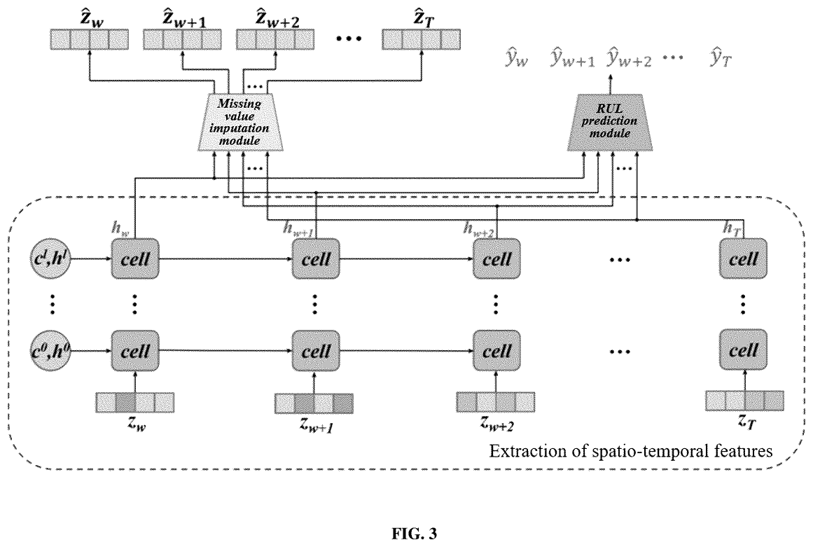

In order to obtain accurate RUL prediction results by using the input data with the missing values, available information in the data needs to be fully utilized. In order to achieve this purpose, a deep LSTM model is used in this method to fully fuse spatio-temporal information in input data. Specifically, for an input data sequence Sₙ={z_{w}, z_{w+1}, . . . , z_{T}}, elements therein are input into the deep LSTM module in the time sequence iteratively, therefore at the moment of t, an implicit representation vector hₜ output from a cell at the moment of t corresponding to the LSTM at the last layer fuses information in all input data (namely {z_{w}, z_{w+1}, zₜ}) at and before the moment of t, and in this way, it is ensured that the hₜ may fully fuse time related information in time series data. In addition, the data flow in the LSTM cells ensures that the input data zₜ at the moment of t may fully fuse spatial correlation therein, namely, related information among sensors. The schematic diagram of this process is shown in FIG. 3.

C. Multi-task Learning

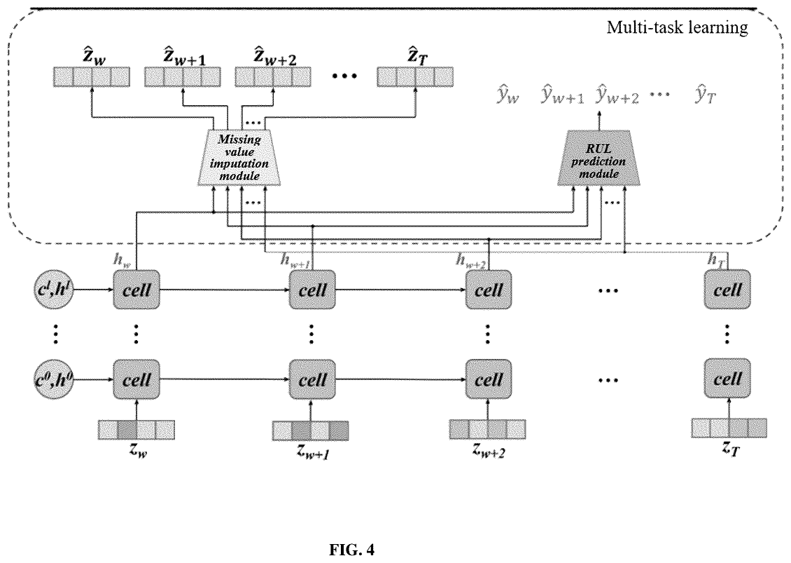

As described above, in order to obtain more accurate RUL prediction results under the condition that the input data has lots of random missing values, the present disclosure designs a multi-task learning-based method. A missing data imputation task and an RUL prediction task are performed in parallel, and an implicit representation hₜ containing complete information is obtained with the aid of the missing value imputation task to obtain a higher RUL prediction accuracy by using the complete information in the hₜ. The process is shown in FIG. 4.

Specifically, the implicit representation hₜ output at the moment of t in step C is input into the modules (the missing value imputation module and the RUL prediction module) corresponding to the two tasks simultaneously in parallel. Wherein, the missing value imputation module consists of a multilayer fully-connected neural network, of which an output dimension corresponds to a dimension of input data zₜ. Supposing that an output value of the missing value imputation module is \hat{z}ₜ, and complete data corresponding to input data zₜ with missing values is \tilde{z}ₜ, the purpose of the missing value imputation module is to shorten the distance between \hat{z}ₜ and \tilde{z}ₜ as far as possible, that is, missing data in the input value zₜ at the moment of t is imputed. An error of the missing value imputation module is computed by mean square error (MSE) loss:

$${L}_{imp} = \frac{1}{( T - w + 1 ) D} {\sum }_{t = w}^{T} {‖ {\hat{z}}_{t} - {\tilde{z}}_{t} ‖}^{2}$$

Where, D=wxS, which is the dimension of an output vector of the missing value imputation module. The recovery of the missing data from zₜ by the missing value imputation module may achieved by optimizing the above loss function, to ensure that the input implicit representation vector hₜ contains complete information in the complete data \tilde{z}ₜ at the moment of t.

Meanwhile, the implicit representation hₜ containing the complete information in the complete data \tilde{z}ₜ at the moment of t is input into the RUL prediction module in parallel, to achieve the RUL prediction task. The RUL prediction module consists of a one-dimensional convolutional neural network (1d-CNN) and a fully-connected layer, wherein the purpose of the (1d-CNN) is to further fully extract degradation features from the implicit representation hₜ, and then send the extracted degradation features into the fully-connected layer to obtain accurate RUL prediction results. As the input hₜ of the RUL prediction module is obtained with the aid of the missing value imputation module in parallel therewith, it contains the complete information at the moment of t, and therefore, a high prediction accuracy may be obtained by using the hₜ for RUL prediction. Supposing that a predicted value output from the RUL prediction module at the moment of t is ŷₜ, a real RUL value at the moment of t is yₜ, as the RUL prediction task is a regression problem, RUL prediction errors are computed by MSE loss frequently used in the regression problem:

$${L}_{pred} = \frac{1}{T - w + 1} {\sum }_{t = w}^{T} {( {\hat{y}}_{t} - {y}_{t} )}^{2}$$

A final loss function of the provided method is as follows:

L=L_{pred}+α·Lᵢₘₚ

Where, α is a hyper-parameter, which is used for balancing L_{pred} and Lᵢₘₚ, and needs to be determined by experiments. In the present disclosure, the above loss function is optimized by a stochastic gradient descent algorithm.

The present disclosure may be understood better with reference to the flow chart of the method.

The multi-task learning-based RUL prediction method provided by the present disclosure can obtain accurate RUL prediction results under the condition that input data has random missing values, which is greatly improved compared with the RUL prediction method in which data with missing values is used directly. Therefore, in practical RUL prediction applications, a higher RUL prediction accuracy can be effectively obtained under the condition of monitoring data missing due to widespread interference factors such as vibration and electromagnetic interference in industrial fields, and the influence of the interference factors on the RUL prediction is reduced as far as possible; the accuracy and reliability of monitoring of equipment are improved, and therefore equipment maintenance and management decisions are made properly to achieve robust and intelligent monitoring, maintenance and management of the industrial equipment.

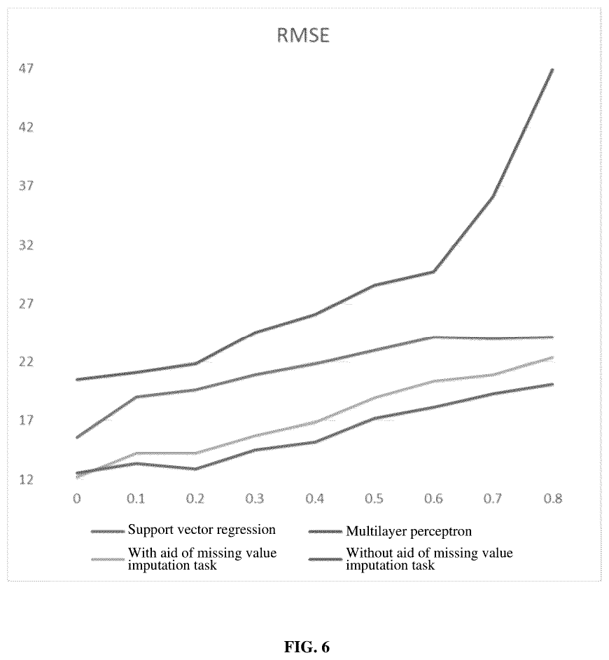

In order to validate the effectiveness of the provided method, comparative experimental studies were conducted on the subdata set FD001 of the aero-engine degradation simulation data set (C-MAPSS data set) published by the National Aeronautics and Space Administration (NASA). Selected comparative methods include support vector regression, multilayer perceptron, and the presence or absence of the missing value imputation module in the provided method. Experiments were performed by the above mentioned methods at a missing rate of 0 to 0.8, and a Root Mean Square Error (RMSE) served as an evaluation index of a prediction accuracy. The experimental results were shown in FIG. 6.

In FIG. 6, a horizontal axis represents different data missing rates, a longitudinal axis represents RMSE values of prediction results, and each curve represents RMSE predicted by a certain method at different missing rates. It can be seen that the provided method has the highest RUL prediction accuracy at multiple different missing rates compared with other comparative methods, which fully validates the effectiveness of the provided method. In addition, the aided effect of the missing value imputation module was also validated, since the prediction error in the presence of the missing value imputation module was obviously lower than that in the absence of the missing value imputation module.

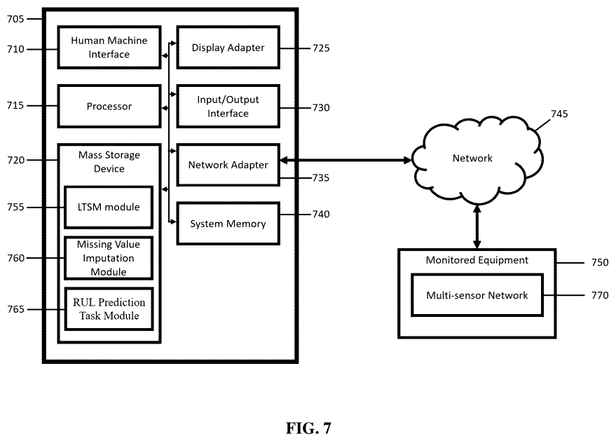

FIG. 7 is a block diagram illustrating an exemplary computing system in which the present system and method can operate provided by an embodiment of the present disclosure.

Referring to FIG. 7, the methods and systems of the present disclosure may be implemented on one or more computers, such as computer 705. The methods and systems disclosed may utilize one or more computers to perform one or more functions in one or more locations. The processing of the disclosed methods and systems may also be performed by software components. The disclosed systems and methods may be described in the general context of computer-executable instructions such as program modules, being executed by one or more computers or devices. For example, the program modules include operating modules such as LTSM module 755, missing value imputation module 760, RUL prediction task module 765, and the like. LTSM module 755 is configured to extract implicit representations containing complete degradation information. Missing value imputation module 760 utilizing the implicit representations, is configured to perform the missing value imputation task. Simultaneously, RUL prediction task module 765 utilizing the implicit representations, is configured to perform the RUL prediction task. These program modules may be stored on mass storage device 720 of one or more computers devices, and may be executed by one or more processors, such as processor 715. Mass storage device 720 is a non-transitory computer readable medium, and may be, for example, without limitation, a solid state drive, a hard drive, flash memory, etc. Each of the operating modules may comprise elements of programming and data management software.

The components of the one or more computers may comprise, but are not limited to, one or more processors or processing units, such as processor 715, system memory 740, mass storage device 720, Input/Output Interface 730, display adapter 725, network adaptor 735, and a system bus that couples various system components. The one or more computers and Monitored Equipment 750 may be implemented over a wired or wireless network connection at physically separate locations, implementing a fully distributed system. Additionally, Monitored Equipment 750 may include the one or more computers such that Monitored Equipment 750 and the one or more computers may be implemented in a same physical location. By way of example, without limitation, the one or more computers may be a personal computer, a portable computer, a smart device, a network computer, a peer device, or other common network node, and so on. Logical connections between one or more computers and Monitored Equipment 750 may be made via network 745, such as a local area network (LAN) and/or a general wide area network (WAN).

Monitored Equipment 750 may be any type of equipment capable of being monitored via PHM. For example, without limitation, monitored equipment 750 may be medical equipment such as an ultrasound machine, patient monitoring system, etc., industrial machinery such as power saws, metal-working machines, etc., specialized machinery such as components of an airplane, etc. Depending on the type of monitored equipment, one or more sensors may be equipped to monitored equipment 750 as multi-sensor network 770. One or more sensors may include, for example, without limitation, thermometers, pressure sensors, voltage sensors, humidity sensors, etc. Multi-sensor network 770 is configured to obtain data from the one or more sensors and transmit the data to computer 705 via network 745. The data from monitored equipment 750 is input into the modules of computer 705, such as LTSM module 755.

The foregoing description of the present disclosure, along with its associated embodiments, has been presented for purposes of illustration only. It is not exhaustive and does not limit the present disclosure to the precise form disclosed. Those skilled in the art will appreciate from the foregoing description that modifications and variations are possible considering the said teachings or may be acquired from practicing the disclosed embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the said-described embodiments, but instead is defined by the appended claims considering their full scope of equivalents.

1. A multi-task learning-based remaining useful life (RUL) prediction method under a sensor fault condition implemented via a processor, comprising the following steps:
implementing a multi-sensor network on monitored equipment and collecting monitoring data via the multi-sensor network;
preprocessing the monitoring data with missing values via a sliding window to construct the monitoring data into data samples in a sequential pattern;
fully fusing spatio-temporal information in the monitoring data via a deep long short-term memory (LSTM) module to extract implicit representations containing complete degradation information;
inputting the implicit representations extracted from the deep LSTM module into a missing value imputation module and an RUL prediction task module via a multi-task learning method in parallel, thereby ensuring that the implicit representations contain as complete degradation information as possible with the aid of a missing value imputation task to obtain accurate RUL prediction results;
utilizing the RUL prediction results to accurately predicate a service life of the monitored equipment; and
performing maintenance and management of the monitored equipment based on the RUL prediction results.

2. The multi-task learning-based RUL prediction method under the sensor fault condition according to claim 1,
wherein the preprocessing comprises the following steps:
representing a set of collected monitoring data with a matrix X=[x₁, x₂, x₃, x₄, x₅, x_{T}], wherein T represents a length of collected signals, a vector therein xₜ=[xₜ¹,xₜ², . . . , xₜ^{S},]^{T}, representing a vector consisting of monitoring signals collected from S sensors of the multi-sensor network at the moment of t, each element xₜ^{s} in the vector representing signals collected from the S sensors at the moment of t, different sensors representing different monitoring features, and 0 representing a missing value; and
partitioning the monitoring data X by a sliding window with a length of w along a time dimension at a step length of 1 for sliding window processing to obtain a plurality of samples {Xₜ}_{W}^{T}, where Xₜ=[x_{t-w+1}, x_{t-w+2}, . . . , xₜ], expanding each sample Xₜ into avector zₜ=[x_{t-w+1}¹, x_{t-w+2}¹, . . . , x_{t-w+1}², x_{t-w+2}², . . . , xₜ², . . . xₜ^{S}], having dimensions WxS; obtaining T-w+1 vectors for X containing monitoring data for T moments in an nth group through sliding window processing, and arraying the T-w+1 vectors in a time sequence to form an nth sample sequence Sₙ={z_{w}, z_{w+}, . . . , z_{T}}, a plurality of which forming a data set used for training and testing models.

3. The multi-task learning-based RUL prediction method under the sensor fault condition according to claim 2, wherein the fusing comprises fully fusing the spatio-temporal information in the input data by the deep LSTM model: for an input data sequence Sₙ={z_{w}, z_{w+1}, . . . ,z_{T}}, and inputting elements therein into the deep LSTM module in a time sequence iteratively, thereby ensuring that, at the moment of t, an implicit representation vector hₜ output from a cell corresponding to the LSTM at a last layer fuses information in all input data of Sₙ={z_{w}, z_{w+1}, . . . , zₜ} at and before the moment of t.

4. The multi-task learning-based RUL prediction method under the sensor fault condition according to claim 3, wherein the multi-task learning comprises performing a missing data imputation task and an RUL prediction task in parallel by the multi-task learning method, and obtaining the implicit representation vector hₜ containing complete information with the aid of the missing value imputation task, to obtain a higher RUL prediction accuracy by using the complete information in the hₜ;
wherein the inputting the implicit representation hₜ output at the moment oft into the missing value imputation module and the RUL prediction module corresponding to the two tasks is performed simultaneously in parallel, wherein the missing value imputation module comprises a multilayer fully-connected neural network, of which an output dimension corresponds to a dimension of input data zₜ; an output value of the missing value imputation module is \hat{z}ₜ, complete data corresponding to input data zₜ with the missing value is \tilde{z}ₜ, the missing value imputation module is configured to shorten a distance between \hat{z}ₜ and \tilde{z}ₜ by imputing missing data in the input value zₜ at the moment of t, and computing an error of the missing value imputation module by mean square error (MSE) loss:
$${L}_{imp} = \frac{1}{( T - w + 1 ) D} {\sum }_{t = w}^{T} {‖ {\hat{z}}_{t} - {\tilde{z}}_{t} ‖}^{2}$$
wherein, D=wxS, which is the dimension of an output vector of the missing value imputation module, a recovery of the missing data from zₜ by the missing value imputation module is achieved by optimizing the MSE loss, to ensure that the input implicit representation vector hₜ contains complete information in the complete data \tilde{z}ₜ at the moment of t;
inputting the implicit representation hₜ containing the complete information in the complete data \tilde{z}ₜ at the moment of t into the RUL prediction module in parallel to achieve the RUL prediction task, wherein the RUL prediction module comprises a one-dimensional convolutional neural network (1d-CNN) and a fully-connected layer, the 1d-CNN is configured to further fully extract degradation features from the implicit representation hₜ and send the extracted feature vectors into the fully-connected layer to obtain accurate RUL prediction results; wherein the input hₜ of the RUL prediction module is obtained via the missing value imputation module in parallel therewith, the input hₜ contains complete information at a moment of t; the hₜ is configured to be used for RUL prediction to obtain a high prediction accuracy; when a predicted value output from the RUL prediction module at the moment of t is ŷₜ, a real RUL value at the moment of t is yₜ, and RUL prediction errors are computed by MSE loss according to:
$${L}_{pred} = \frac{1}{T - w + 1} {\sum }_{t = w}^{T} {( {\hat{y}}_{t} - {y}_{t} )}^{2}$$
and a final loss function is computed as follows:
L=L_{pred}+α·Lᵢₘₚ
where, α is a hyper-parameter used for balancing L_{pred} and Lᵢₘₚ.

5. A system for multi-task learning-based remaining useful life (RUL) prediction method under a sensor fault condition, comprising:
a processor;
monitored equipment;
a multi-sensor network implemented on the monitored equipment; and
a computer readable medium, the computer readable medium configured to store the multi-task learning-based RUL prediction method, wherein the processor is configured to execute steps to perform the multi-task learning-based RUL prediction method, the steps comprising:
collecting monitoring data via the multi-sensor network;
preprocessing the monitoring data with missing values via a sliding window to construct the monitoring data into data samples in a sequential pattern;
fully fusing spatio-temporal information in the monitoring data via a deep long short-term memory (LSTM) module to extract implicit representations containing complete degradation information;
inputting the implicit representations extracted from the deep LSTM module into a missing value imputation module and an RUL prediction task module via a multi-task learning method in parallel, thereby ensuring that the implicit representations contain as complete degradation information as possible with the aid of a missing value imputation task to obtain accurate RUL prediction results;
utilizing the RUL prediction results to accurately predicate a service life of the monitored equipment; and
performing maintenance and management of the monitored equipment based on the RUL prediction results.

6. The system according to claim 5, wherein the preprocessing comprises the following steps:
representing a set of collected monitoring data with a matrix X=[x₁, x₂, x₃, x₄, x₅, . . . , x_{T}], wherein T represents a length of collected signals, a vector therein xₜ=[xₜ¹, xₜ², . . . , xₜ^{S},]^{T}, representing a vector consisting of monitoring signals collected from S sensors of the multi-sensor network at the moment of t, each element xₜ^{S} in the vector represents signals collected from the S sensors at the moment of t, different sensors represent different monitoring features, and 0 represents the missing value; and
partitioning the monitoring data X by a sliding window with a length of w along a time dimension at a step length of 1 for sliding window processing to obtain a plurality of samples {Xₜ}_{w}^{T}, where Xₜ=[x_{t-w+1}, x_{t-w+2}, . . . , xₜ], expanding each sample Xₜ into a vector zₜ=[x_{t-w+1}¹, x_{t-w+2}¹, . . . , x_{t-w+1}², x_{t-w+2}², . . . , xₜ², . . . xₜ^{S}], having dimensions are WxS; obtaining T-w+1 vectors for X containing monitoring data for T moments in an nth group through sliding window processing, and arraying T-w+1 vectors in a time sequence to form an nth sample sequence Sₙ={z_{w}, z_{w+1}, . . . , z_{T}}, a plurality of which forming a data set used for training and testing models.

7. The system according to claim 2, wherein the fusing comprises fully fusing the spatio-temporal information in the input data by the deep LSTM model: for an input data sequence Sₙ={z_{w}, z_{w+1}, . . . , z_{T}}, and inputting elements therein into the deep LSTM module in a time sequence iteratively, thereby ensuring that, at the moment of t, an implicit representation vector hₜ output from a cell corresponding to the LSTM at a last layer fuses information in all input data of Sₙ={z_{w}, z_{w+1}, . . . , zₜ} at and before the moment of t.

8. The system according to claim 7, wherein the multi-task learning comprises performing a missing data imputation task and an RUL prediction task in parallel by the multi-task learning method, and obtaining the implicit representation vector hₜ containing complete information with the aid of the missing value imputation task, to obtain a higher RUL prediction accuracy by using the complete information in the hₜ;
wherein the inputting the implicit representation hₜ output at the moment oft into the missing value imputation module and the RUL prediction module corresponding to the two tasks is performed simultaneously in parallel, wherein the missing value imputation module comprises a multilayer fully-connected neural network, of which an output dimension corresponds to a dimension of input data zₜ; an output value of the missing value imputation module is \hat{Z}ₜ, complete data corresponding to input data zₜ with the missing value is \tilde{z}ₜ, the missing value imputation module is configured to shorten a distance between \hat{z}ₜ and \tilde{z}ₜ by imputing missing data in the input value zₜ at the moment of t, and computing an error of the missing value imputation module by mean square error (MSE) loss:
$${L}_{imp} = \frac{1}{( T - w + 1 ) D} {\sum }_{t = w}^{T} {‖ {\hat{z}}_{t} - {\tilde{z}}_{t} ‖}^{2}$$
wherein, D=wxS, which is the dimension of an output vector of the missing value imputation module, a recovery of the missing data from zₜ by the missing value imputation module is achieved by optimizing the MSE loss, to ensure that the input implicit representation vector hₜ contains complete information in the complete data \tilde{z}ₜ the moment of t;
inputting the implicit representation hₜ containing the complete information in the complete data \tilde{z}ₜ at the moment of t into the RUL prediction module in parallel to achieve the RUL prediction task, wherein the RUL prediction module comprises a one-dimensional convolutional neural network (1d-CNN) and a fully-connected layer, the 1d-CNN is configured to further fully extract degradation features from the implicit representation hₜ and send the extracted feature vectors into the fully-connected layer to obtain accurate RUL prediction results; wherein the input hₜ of the RUL prediction module is obtained via the missing value imputation module in parallel therewith, the input hₜ contains complete information at a moment of t; the hₜ is configured to be used for RUL prediction to obtain a high prediction accuracy; when a predicted value output from the RUL prediction module at the moment of t is ŷₜ, a real RUL value at the moment of t is yₜ, and RUL prediction errors are computed by MSE loss according to:
$${L}_{pred} = \frac{1}{T - w + 1} {\sum }_{t = w}^{T} {( {\hat{y}}_{t} - {y}_{t} )}^{2}$$
and a final loss function is computed as follows:
L=L_{pred}+α·Lᵢₘₚ
where, α is a hyper-parameter used for balancing L_{pred} and Lᵢₘₚ.
